(19) United States
(12) Patent Application Publication
(10) Pub. No.: US 2016/0100019 A1
(43) Pub. Date: Apr. 7, 2016

(54) Contextual Presence Systems and Methods

(71) Applicant: Clique Intelligence, Redwood City, CA (US)

(72) Inventor: Art Leondires, Redwood City, CA (US)

(21) Appl. No.: 14/873,703

(22) Filed: Oct. 2, 2015

Related U.S. Application Data
(60) Provisional application No. 62/059,772, filed on Oct. 3, 2014.
(60) Provisional application No. 62/136,270, filed on Mar. 20, 2015.

(51) Int. Cl. H04L 29/08

(52) U.S. Cl. CPC H04L 67/24

(57) ABSTRACT

Systems and methods are provided for managing contextual collaborations. A plurality of contextual collaborations are associated with a plurality of users and resources. A first interaction associated with a first contextual collaboration is receive from a first computing device associated with a first user. The first interaction is stored in association with the first user and the first contextual collaboration. A first status associated with the first user and the first contextual collaboration is updated. The first status is transmitted, over a network, to computing devices associated with at least a first portion of the plurality of users associated with the first contextual collaboration. The first contextual collaboration is one of the plurality of contextual collaborations. The first user is one of the plurality of users associated with the first contextual collaboration.

### CROSS REFERENCE TO RELATED APPLICATIONS

The present application claims the benefit of and priority to U.S. Provisional Application No. 62/059,772, filed on Oct. 3, 2014 and titled “CONTEXTUAL PRESENCE SYSTEMS AND METHODS”; and U.S. Provisional Application No. 62/136,270, filed on Mar. 20, 2015, and titled “SYSTEMS AND METHODS FOR PROVIDING CONTEXTUAL PRESENCE,” the entire contents of which are hereby incorporated by reference herein.

The present application is related to U.S. Provisional Application No. 62/059,789, filed on Oct. 3, 2014 and titled “SYSTEMS AND METHODS FOR DOCUMENT-LEVEL ACCESS CONTROL IN A CONTEXTUAL COLLABORATION FRAMEWORK”; U.S. Provisional Application No. 62/136,262, filed on Mar. 20, 2015, and titled “SYSTEMS AND METHODS FOR PROVIDING ACCESS-CONTROL IN CONTEXTUAL COLLABORATIONS”; and International Application No. PCT/US14/59154, filed on Oct. 3, 2014, and titled “SYSTEMS AND METHODS FOR ENTERPRISE MANAGEMENT USING CONTEXTUAL GRAPHS,” the entire contents of which are hereby incorporated by reference herein.

### FIELD OF THE INVENTION

The present invention generally relates to contextual collaborations. More particularly, the present invention relates to systems and methods for providing contextual presence in contextual collaborations.

### BACKGROUND

The number of interconnected computing devices and people continues to increase globally. Some estimates indicate that as many as fifty or even seventy five billion devices may be interconnected by the year 2020. Interconnectivity has allowed for the expansion of computer-supported collaboration among groups of people and entities such as enterprises, organizations, companies, schools, governments, communities, and the like.

Managing such collaborations, including the vast amounts of data, users and devices associated with those collaborations, has resulted in the development of systems, such as enterprise systems, that provide the necessary interconnectivity to communicate and utilize data in a collective manner. Enterprise systems are frequently used in accounting, manufacturing, order processing, supply chain management, project managements, customer relationship management, self-service interfaces, and the like.

Entities, by employing such systems (e.g., enterprise systems), allow users anywhere in the world to work collaboratively towards common goals, for example, via contextual collaborations. Contextual collaboration refers to the concept of grouping and sharing resources among users and/or devices to achieve a collective objective, such as a project, lifecycle, process, and the like. The grouping of resources in contextual collaborations is performed in a structured and organized manner, so as to enable more efficient and effective cooperation. Some of the resources grouped and shared via contextual collaborations include tools (e.g., services), documents, discussions, files, data, permissions, users, priorities, tasks, statuses, and the like. Contextual collaborations are described in more detail in U.S. Provisional Patent Application Nos. 62/059,772 and 62/059,789, respectively titled “CONTEXTUAL PRESENCE SYSTEMS AND METHODS” and “SYSTEMS AND METHODS FOR DOCUMENT-LEVEL ACCESS CONTROL IN A CONTEXTUAL COLLABORATION FRAMEWORK,” and filed on Oct. 3, 2014. The entire contents of these applications are hereby incorporated herein by reference in their entireties.

Moreover, interconnectivity allows users and/or participants associated with contextual collaborations to communicate, often in real-time (e.g., chat, post). Traditionally, the presence (e.g., status) of users has not been shared with other users associated with the contextual collaboration or, their general presence has been shared with the other users associated with the contextual collaboration.

Given the foregoing, it would be beneficial to provide systems and methods that allow users associated with a contextual collaboration to be aware of the presence (e.g., status) of other users associated with the contextual collaboration. It would also be beneficial to share users' statuses within and with regard to a contextual collaboration.

### SUMMARY

The disclosed technology provides a system that indicates the presence status of users associated with, and who are working within, one or more collaborative workspaces of a context-based collaboration system, e.g., implemented over a computer network. In short, the presence status is a graphical indication of access by registered users of a particular workspace of that collaboration system, presented to promote engagement and collaboration among users when they are concurrently accessing the same workspace.

However, rather than simply indicating whether a user is “online” or not, as with a simple instant messaging client, the system provides a context-based graphical indication to a given user of the presence and/or activity of other users within a workspace to which the given user is registered (e.g., to which the user has applicable permissions). The indicator may be further limited to workspaces which the given user has currently accessed, from that user's list of available contextual collaboration workspaces. The indication of users' presence is influenced by context, and is presented in a way that preserves the privacy of users and confidentiality of information in the collaboration system. Moreover, the presence status indicator is tailored to each individual user, since the list of contextual collaboration workspaces available to a user varies from user to user.

In one aspect, the present disclosure describes, within a collaborative system for creating and managing a collection of contextual collaborations for users (e.g., users associated with an enterprise), a method for notifying a first user of the presence of other users in a participant list associated with a contextual collaboration accessed by the first user. The method includes determining, via a processor of a computing device of the system, a presence status of each of one or more users in the participant list associated with a first contextual collaboration, wherein the presence status indicates access by a given user of a given contextual collaboration workspace.

The method further includes causing, via the processor, upon access by the first user of a workspace associated with the first contextual collaboration (e.g., the workspace accessed by the first user by selection from a list of contextual collaborations of which the first user is a participant, e.g., a registered participant), a presence status indicator to be graphically rendered within an instance of the accessed workspace (e.g., workspace window) as viewed by the first user, said indicator graphically indicating a presence status of one or more other users in the participant list associated with the first contextual collaboration.

In some embodiments, the presence status indicator graphically indicates the one or more users whom are accessing a workspace associated with the first contextual collaboration (e.g., having a workspace presented to) (e.g., indicating an interruptible status for a user if the user is accessing the same workspace as that being accessed by the first user and, e.g., indicating an unavailable status if the user is accessing a different workspace from that being accessed by the first user).

In another aspect, the present disclosure describes a system for creating and managing a collection of contextual collaborations for users (e.g., users associated with an enterprise). The system includes a processor and a memory, the memory storing instruction that, when executed by the processor, cause the processor to notify a first user of the presence of other users in a participant list associated with a contextual collaboration accessed by the first user.

The notification comprises the processor performing the steps of: determining a presence status of each of one or more users in the participant list associated with a first contextual collaboration, the presence status indicating access by a given user of a given contextual collaboration workspace.

The notification further comprises the processor performing the steps of causing, upon access by the first user of a workspace associated with the first contextual collaboration (e.g., the workspace accessed by the first user by selection from a list of contextual collaborations of which the first user is a participant, e.g., a registered participant), a presence status indicator to be graphically rendered within an instance of the accessed workspace (e.g., workspace window) as viewed by the first user, said indicator graphically indicating a presence status of one or more other users in the participant list associated with the first contextual collaboration.

In some embodiments, the presence status indicator graphically indicates the one or more users whom are accessing a workspace associated with the first contextual collaboration (e.g., having a workspace presented to) (e.g., indicating an interruptible status of a user if the user is accessing an instance of the same workspace as with the first user and, e.g., indicating an unavailable status if the user is accessing an instance of a different workspace as with the first user).

### BRIEF DESCRIPTION OF THE DRAWINGS

The foregoing and other objects, aspects, features, and advantages of the present disclosure will become more apparent and better understood by referring to the following description taken in conjunction with the following drawings.

FIG. 1 is a screenshot of a graphical user interface for displaying a context list of contextual collaborations in accordance with an exemplary embodiment.

FIG. 2 is a screenshot of a graphical user interface for displaying a contextual collaboration in accordance with an exemplary embodiment.

FIGS. 3A and 3B are screenshots of graphical user interfaces for displaying a contextual collaboration workspace in accordance with an exemplary embodiment.

FIG. 4 is a flowchart illustrating a method for providing the presence status of users associated with a contextual collaboration in accordance with an exemplary embodiment.

FIG. 5 is a block diagram of a system for enterprise management using contextual collaborations in accordance with an exemplary embodiment.

FIG. 6 is a block diagram of a system for enterprise management using contextual collaborations in accordance with an exemplary embodiment.

FIG. 7 illustrates a screenshot of a portion of a graphical user interface for modifying a presence status in accordance with an exemplary embodiment.

FIG. 8 shows a block diagram of an exemplary cloud computing environment.

FIG. 9 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The example embodiments described herein are directed to systems and methods for providing contextual presence.

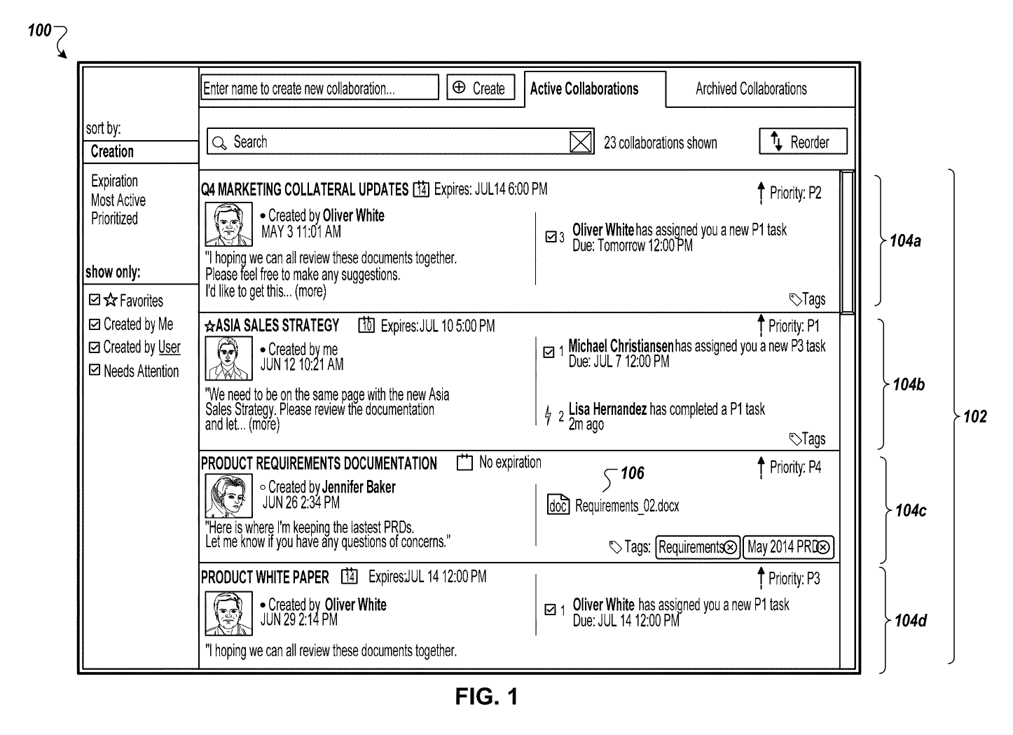

More specifically, the example embodiments described herein provide a graphical indication of a status (e.g., presence status) of users associated with contextual collaborations. Contextual collaborations are described in more detail below with reference to FIGS. 1-7.

In one example implementation, an enterprise system provides contextual collaborations (e.g., contextual graphs) that relate resources occurring in business workflows. The contextual collaborations provide a unified collaborative tool and presentation workspace to access people, resources, and tools associated with the contextual collaboration, for example, to complete a project or task. Resources such as files, users, permissions, priorities, individual tasks, statuses, and assets are grouped in a contextual collaboration and accessible via workspaces that are based around the context of completing the task or project. The enterprise system, in some example implementations, provides a collaboration framework that is neatly and intuitively organized within the context of a project or task.

The presence status of a user indicates access by the user of a workspace and/or resources associated with a contextual collaboration. The system allows users to view other users' presence status via the contextual collaboration workspaces, in order to promote and facilitate the engagement and cooperation among the users, while maintaining privacies of the users and confidentiality of the information and content that they are accessing and/or sharing.

FIG. 1 is a screenshot of a graphical user interface 100 for displaying a context list of contextual collaborations, in accordance with an exemplary embodiment. More specifically, the graphical user interface 100 displays a context list 102 of contextual collaborations 104a, 104b, 104c, and 104d (collectively “104” or “contextual collaborations 104”).

In some example implementations, a graphical user interface (“GUI”) is an interface through which users interact with computing and/or electronic devices. More specifically, using a GUI, users can interact with computing devices by manipulating (e.g., clicking, moving, tapping, selecting, pinching, rotating) graphical elements and/or components typically rendered and/or displayed via a screen, monitor, and the like. In some example implementations, the graphical user interface 100 is displayed via a screen (corresponding to a system (e.g., computer, tablet, mobile device)) managed, operated and/or owned by a user.

In some example implementations, the context list 102 includes a list, table, feed, timeline, and the like, of contextual collaborations 104 with which a user, user system, and/or user account is associated. It should be understood that being associated with a contextual collaboration may include being a creator, owner, participant, operator, contributor, manager, viewer, and the like, with respect to a contextual collaboration. In some example implementations, the context list may be designed, ordered and/or displayed in accordance with preset and/or predetermined requirements, filters, options, and the like, associated with a user and/or user account.

More specifically, the context list 102 includes overview and/or summary information regarding each of the contextual collaborations 104. For example, the context list 102 may include, for each of the contextual collaborations 104a-104d, a contextual collaboration name and/or title, expiration date, creator, creation date, discussions, outstanding tasks, recent activity, priority, tags, associated documents, and the like.

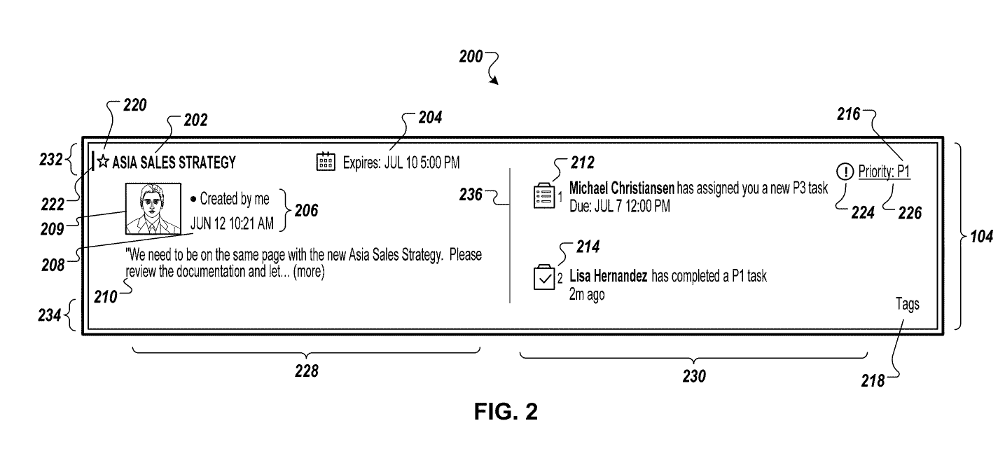

The contextual collaboration name and/or title (e.g., “Q4 MARKETING COLLATERAL UPDATES,” “ASIA SALES STRATEGY,” “PRODUCT REQUIREMENTS DOCUMENTATION,” “PRODUCT WHITE PAPER”) may be text assigned to a contextual collaboration at the time the contextual collaboration is created and/or modified throughout the lifecycle of the contextual collaboration. The expiration date (e.g., contextual collaboration 104a: “JUL 14 6:00 PM”) indicates an assigned date and/or time on which the contextual collaboration is set to expire, which may be the date a project is due. The creator may be the name (e.g., first, last), user name, pseudonym, login name, and the like (e.g., contextual collaboration 104a: “Oliver White”), associated with a user who created the contextual collaboration. The creation date may be the date on which a contextual collaboration was generated (e.g., contextual collaboration 104a: “MAY 3 11:01 AM”). The discussions may be messages, posts, e-mails, threads, tweets, and the like, associated with a contextual collaboration. For each of the contextual collaborations 104, the context list 102 may include any number of discussions (e.g., messages). Moreover, the displayed discussions may be the newest discussion, one flagged with highest priority, one generated by a particular user (e.g., creator), one unread (e.g., not yet viewed), or any other discussion selected in accordance with predetermined criteria. For example, in FIG. 1, the discussion displayed with relation to contextual collaboration 104a reads: “I hoping we can all review these documents together. Please feel free to make any suggestions. I'd like to get this . . . (more).” The “(more)” text may be a link to display the entire discussion. The outstanding tasks may include tasks that are pending action and/or tasks that have been generated, assigned to the user associated with the GUI 100, and/or tasks that have not yet been read by the user associated with the GUI 100. For example, in FIG. 1, the contextual collaboration 104a includes a “new P1 task” assigned by Oliver White and due “Tomorrow 12:00 PM.” In some example implementations, recent activity may include the creation of new tasks, such as “new P1 task” associated with the contextual collaboration 104a. In some example implementations, recent activity may include the completion of tasks (e.g., contextual collaboration 104b: “Lisa Hernandez has completed a P1 task”). The priority may refer to text, an icon, or the like that indicates a level and/or order of priority for each contextual collaboration. In some example implementations, the priority may be indicated by identifiers P1, P2, P3 and P4 (e.g., P1 indicating highest level of priority). In this manner, the user associated with the GUI 100 can identify the importance of the contextual collaborations. The tags may refer to a text, icon, or the like that can be used to quickly identify contextual collaborations having the same tag. That is, in FIG. 1, for example, the contextual collaboration 104c includes tags “Requirements” and “May 2014 PRD,” which server to identify the contextual collaboration as a requirements (e.g., product requirements) related collaboration, particularly a May 2014 product requirements documentation (PRD) contextual collaboration (e.g., “May 2014 PRD”). As described above, other information related to the contextual collaborations, and any number of contextual collaborations, may be displayed in the context list 102. The information included and/or displayed for each contextual collaboration is described in further detail below with reference to FIG. 2.

The context list 102 may be used, for example, to organize and prioritize contextual collaborations, tasks and projects with which they are associated and/or to which they are assigned.

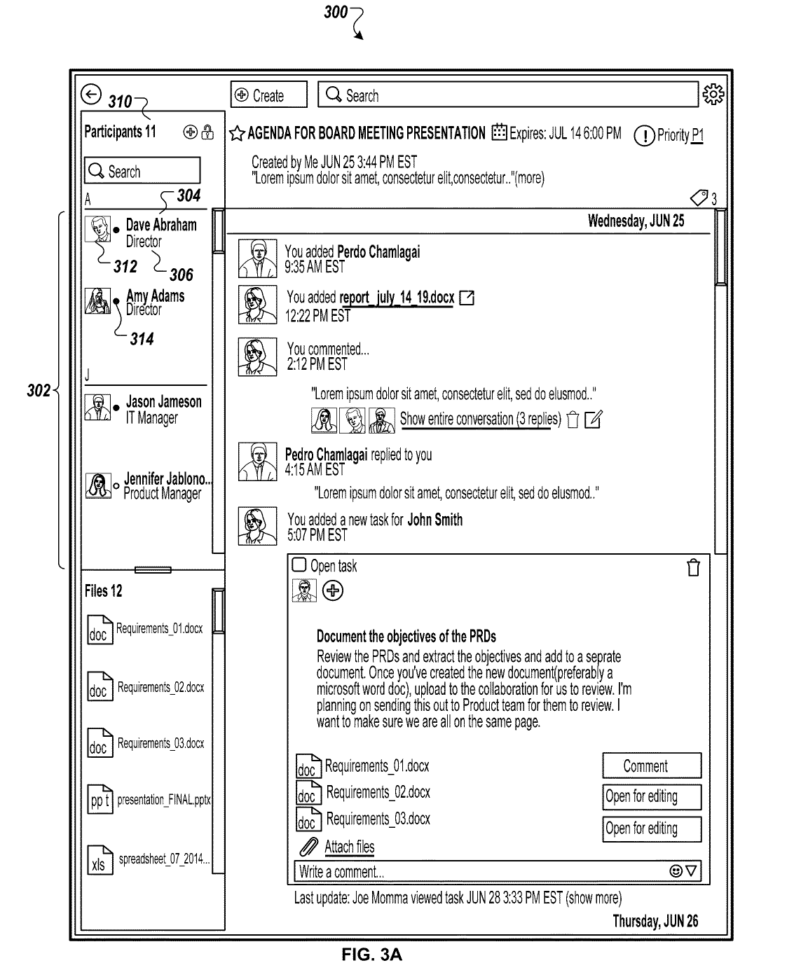

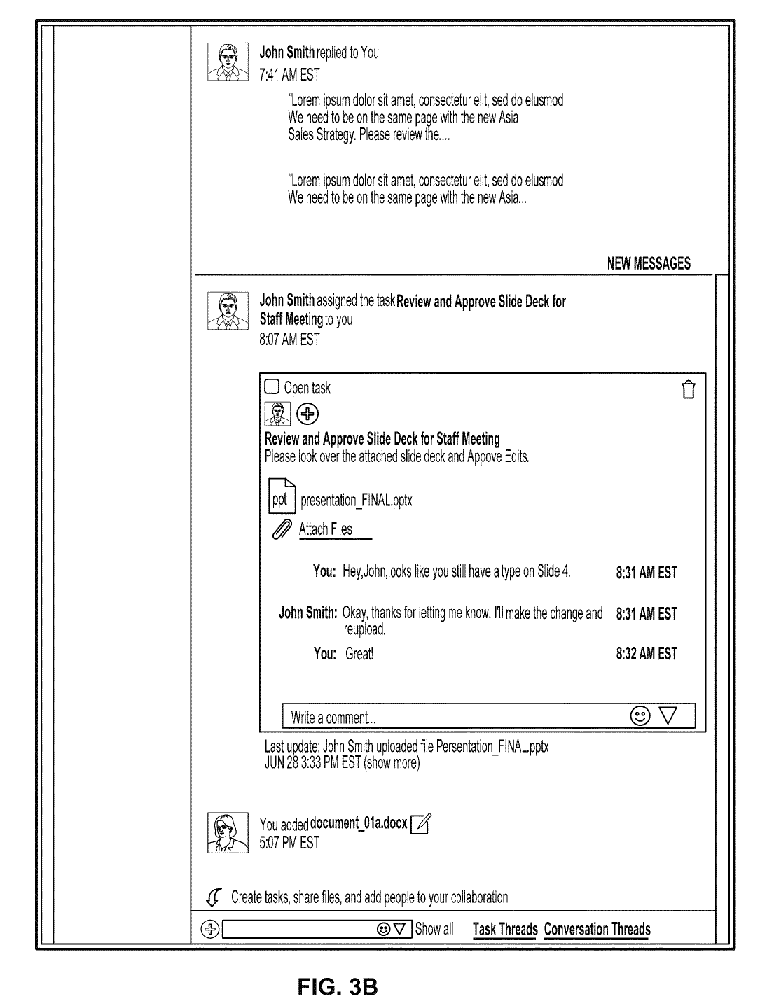

A contextual collaborations with which multiple users are associated may be accessible by each user through a respective workspace. That is, a contextual collaboration that is shared with other users is made available to the users through respective workspaces included in a GUI. In this manner, multiple users associated with a contextual collaboration can contribute and share information, documents, resources, and the like within the context of a contextual collaborations. Workspaces may be individually tailored to each user, for example, to include only information and/or resources to which the user has access. Workspaces are described in more detail below with reference to FIGS. 3A and 3B. The users may include those that are within the same organization/business domain, as well as users external to the organization/domain, assuming access permission is granted.

FIG. 2 is a screenshot of a graphical user interface 200 (or a portion thereof) for displaying a contextual collaboration, in accordance with an exemplary embodiment. It should be understood that displaying a contextual collaboration may include retrieving, requesting, transmitting and/or displaying information associated with the contextual collaboration. The graphical user interface 200 may be displayed at and/or by a system (e.g., computing device) corresponding to a user.

The contextual collaboration 104 (e.g., FIG. 1, contextual collaboration 104b), in some example implementations, includes and/or graphically indicates one or more of a name and/or title 202, expiration date and/or time 204, a creator 206, user icon and/or avatar 207, a creation time 208, discussions 210, tasks 212, statuses 214, priority level 216, tags 218, favorite indicators 220, and change indicators 222. As show in FIG. 2, in some example implementations, the information may be divided by a panel or pane division line 236. That is, for example, the contextual collaboration information may be divided into file, user, messages information 228 and task information 230.

The contextual collaboration name and/or title 202 is described in more detail above with reference to FIG. 1. In some example implementations, the contextual collaboration name and/or title may be text assigned to a contextual collaboration at the time the contextual collaboration is created and/or modified throughout the lifecycle of the contextual collaboration (e.g., “ASIA SALES STRATEGY”). The expiration date and/or time 204 indicates an assigned date and/or time on which the contextual collaboration is set to expire, which may be the date a project is due (e.g., “JUL 10 5:00 PM”). The creator 206 may be the name (e.g., first, last), user name, pseudonym, login name, and the like (e.g., “me”), associated with a user who created the contextual collaboration 104. The user icon and/or avatar 207 may be a picture, image, icon, avatar, and the like associated with the creator 206. The creation time 208 may be a date and/or time (e.g., “JUN 12 10:21 AM”) on which the contextual collaboration 104 was created. The discussions 210 may be messages, posts, e-mails, threads, tweets, and the like, associated with a contextual collaboration (e.g., “We need to be on the same page . . . ”). The contextual collaboration 104 may include any number of discussions (e.g., messages). Moreover, the displayed discussions 210 may be the newest discussion, one flagged with highest priority, one generated by a particular user (e.g., creator), one unread (e.g., not yet viewed), or any other discussion selected in accordance with predetermined criteria. The tasks 212 may include tasks that are pending action and/or tasks that have been generated, completed, assigned to the user associated with the GUI 100, and/or tasks that have not yet been read by the user. The statuses (e.g., recent activity) 214 may include and/or indicate the completion of tasks (e.g., “Lisa Hernandez has completed a P1 task”), as well as an indication of the date and/or time on which the status and/or updated activity was completed (e.g., “2m ago”). The priority level 216 may refer to text, an icon, or the like that indicates a level and/or order of priority for each contextual collaboration. In some example implementations, the priority may be indicated by identifiers P1, P2, P3 and P4 (e.g., P1 indicating highest level of priority). The priority level 216 may be highlighted by underlining (e.g., underlining 226) and/or be accompanied by an icon (e.g., exclamation mark 224) to further emphasize the priority level 216. The tags 218 may refer to a text, icon, or the like that can be used to quickly identify contextual collaborations having the same tag.

A contextual collaborations generally has one or more users associated with it. Users are individuals (including their corresponding systems) who are registered with the system (e.g., contextual collaboration system), have account credentials (e.g., user name, password). Users who generate, add and/or initiate a contextual collaboration are deemed to be creators of that contextual collaboration. Users who add documents and/or other resources to a contextual collaboration are deemed to be owners of the documents and/or resources which they contributed.

Users of a contextual collaboration generally have permission to perform certain actions with respect to the contextual collaboration, based on each user's level (e.g., generic user, creator, owner). Such permissions may include executing commands; receiving notifications; adding, modifying, and/or removing users; adding, modifying, and/or removing documents; adding, modifying, and/or removing resources, instantiating live-share; modifying and/or applying version numbers to documents and/or resources; setting permissions; setting and/or modifying priorities; setting and/or modifying expiration dates; deleting and/or archiving contextual collaborations; changing and/or adding states of contextual collaborations; and the like.

A contextual collaboration generally has one or more resources associated with it. Resources have a lifecycle and exist in at least one contextual collaboration, which can be created, manipulated and ultimately terminated or retired. The contextual collaboration (e.g., contextual graph) structure, in some example implementations, organizes contextual collaborations conceptually on a timeline and/or by priority. To this end, at any point in time a user of the system can view their timeline or priority and see what contexts (and therefore what resources within those contexts) are involved in the activities they are working on.

For example, a contextual collaboration can be in connection with the production, approval, and archival of documents (and/or files). In further example, a context may be framed as a meeting with relationships or links to: the attendees of the meeting, the documents to be presented in the meeting, devices (projectors or displays) that the meeting will use, and the location(s) of the meeting and/or the scheduled time. This contextual collaboration (e.g., contextual graph) information model, is used to orchestrate the meeting. For example, read access to the documents may be granted (e.g., automatically) to the attendees of the meeting once the documents and attendees are associated to the contextual collaboration. Similarly, the documents may be automatically available for display on any display available in any of the meeting locations if associated within the contextual collaboration.

FIGS. 3A and 3B are screenshots of a graphical user interfaces for displaying a contextual collaboration workspace 300. The contextual collaboration workspace 300 serves as an interface to, for example, output information and receive inputs with respect to a contextual collaboration. The contextual collection workspace 300, in some implementations, is accessed by selecting (e.g., tapping, clicking, double-clicking) a contextual collaboration (e.g., 104a-d) from the context list 102. In some example implementations, the contextual collaboration workspace 300 is displayed at a computing device.

More specifically, the contextual collaboration workspace 300 is specific to users (e.g., user systems, user accounts) associated with a contextual collaboration. That is, in some example implementations, each user associated with a contextual collaboration has and/or has access to a corresponding contextual collaboration workspace (e.g., contextual collaboration workspace 300). A user's contextual collaboration workspace includes, displays and/or graphically renders information, resources, and the like associated with the contextual collaboration that is associated with and/or accessible by the user. For example, a non-creator type of user may only have access to a portion of documents, tasks, and the like associated with a contextual collaboration. A creator type of user may have higher permissions (e.g., privileges) and therefore have access to all of the documents, tasks, and the like associated with the same contextual collaboration. In such a scenario, the non-creator type user has (or has access to) a contextual collaboration workspace that is more limited than the contextual collaboration workspace of the creator-type user.

In some example implementations, the contextual collaboration workspace 300 includes (and/or displays) a participant list 302, in which users associated with the contextual collaboration are displayed. The participant list may be tailored (e.g., limited) based on the permissions of the user of the contextual collaboration workspace 300. The participant list 302, in some example implementations, includes a number of users 310 associated with the contextual collaboration. Moreover, the participant list 302 may include, for each user associated with the contextual collaboration and listed in the participant list 302, a name identifier 304, a title 306, an associated organization 308 (not shown), an icon (e.g., avatar, photo) 312, and a presence status indicator 314.

In some example implementation, the presence status indicator 314 shown in a participant list 302 of a contextual collaboration workspace 300 is an indication of the status of users associated with the contextual collaboration. The list of users in the participant list 302 may be display only users which the user of the contextual collaboration workspace 300 has access to. For example, a generic user may not have access to creators, administrators, and/or other types of users and, therefore, those creators, administrators and/or other types of users may not be displayed in a participant list.

The status illustrated by presence status indicator 314 may be determined and/or calculated by based on the users' actions relevant to the contextual collaboration with which the contextual collaboration workspace 300 is associated, and with which the users are associated. That is, the status of the presence status indicator 314 may automatically detected based on, for example, whether a user has acted on and/or interacted with (e.g., moved mouse, entered text, sent message, and the like) a contextual collaboration and/or the information, elements, resources associated therewith. In some example implementations, actions and/or interactions by a user are detected without any request and/or instructions from the user of the contextual collaboration workspace 300. In this way, a user's presence dictates the way the user is represented via a presence status indicator in a contextual collaboration workspace.

In one example, a first user (user 1) is associated with (e.g., a participant of) a first contextual collaboration (contextual collaboration X). User 1 may access the contextual collaboration X via a workspace (workspace X-1). The workspace X-1 may be accessed (e.g., viewed, acted on, interacted with) by user 1 using a system (e.g., computing device) operated, owned and/or managed by user 1, for example, via an application or web browser. User 1 is also associated with (e.g., a participant of) another contextual collaboration (contextual collaboration Y). User 1 may access the contextual collaboration Y via another workspace (workspace Y-1). A second user (user 2) is associated with (e.g., a participant of) the contextual collaboration X and the contextual collaboration Y and accesses those contextual collaborations through a workspace X-2 and workspace Y-2, respectively.

During a first instance (e.g., at or during a time or range of time), user 1 accesses (e.g., opens) a document associated with the contextual collaboration X via the workspace X−1. User 1 does not take any action via the workspace Y-1. During a second instance, user 2 accesses a document associated with the contextual collaboration X via the workspace X-2 and also accesses a document associated with the contextual collaboration Y via the workspace Y-2. In such a case, workspace X-2 corresponding to user 2 shows (e.g., via a presence status indicator) the status of user 1 as available (e.g., on, present, interruptible, or the like), due to the actions of user 1 (e.g., accessing a document) in connection with the contextual collaboration X. Workspace Y-2 corresponding to user 2, on the other hand, does not show (e.g., via a presence status indicator) the status of user 1 as available. That is, the status of user 1 via workspace Y-2 is shown as unavailable (e.g., off, not present, or the like), due to the lack of actions of user 1 in connection with the contextual collaboration Y. In some example implementations, a status may be affected and/or modified based on the passing of time from when an action occurs. That is, for example, a user that accesses a document may be deemed to be active at that instance but may be deemed to be inactive after the passing of a predetermined amount of time (e.g., 20 minutes).

The presence status indicators allow users associated with a contextual collaboration to communicate with each other based on their statuses. In having the presence status presented from within a contextual collaboration workspace, the privacy of the users can be maintained, as only users associated with the same contextual collaboration may have access to the status of each user.

In some example implementations, the presence status indicator 314 is a graphical widget that indicates a presence status of a given user based on color (e.g., red, green, blue, yellow, orange, etc.). For example, the presence status indicator 314 of users having an “available” and/or “interruptible” status may be presented as green; “offline” may be presented as grey; and “unavailable,” “away,” “busy,” and/or “do not disturb” may be presented as yellow or red. Of course, any color and/or shapes may be used to illustrate a user status via a presence status indicator.

In some example implementations, the presence status indicator 314 may be graphically rendered as, or in conjunction with, a text icon or label corresponding to the status of a user. That is, the presence status indicator 314, may be text and/or a label such as “Available,” “Interruptible,” “Unavailable,” “Do Not Disturb,” “Away,” “Busy,” “Invited,” “Offline,” and/or the like. In some example implementation, the text and/or label is rendered over or proximal to the graphical widget presence status indicator 314, for example, when a cursor is placed over the presence status indicator 314.

In some implementations, the name identifier 304 of the user or the icon 312 is highlighted (e.g., bolded, increased size, etc.) to indicate a presence status of a user in connection with a contextual collaboration. Highlighting a status may be used to prompt engagement (e.g., actions and/or interactions with) the user within the workspace. In some implementations, the background color of a given user within the participant list is highlighted to indicate such collaboration-specific presence status. In some implementations, users in the participant list are ordered by presence status, for example, available users above unavailable users.

In some example implementations, the contextual collaboration workspace 300 may include a presence status for a user that is provided (e.g., input, entered) by the user. That is, a user can set and/or modify his/her status. In some example implementations, the “interruptible” status and the “unavailable” status are not modifiable by the user and is reserved specifically as a status that is automatically detected based on the users' actions and/or interactions.

In some example implementations, a user's presence status may be set across contextual collaborations. That is, a user's status can be automatically and/or manually set (e.g., “available,” “away,” “busy,” “do not disturb,” “invited,” “offline”) and maintained until a predetermined condition (e.g., time, type of action, manual change of status) is satisfied. For example, if a user selects a “do not disturb” status, that status will be maintained (and distributed to other contextual collaboration users) for the user as the user remains logged on. In turn, for example, upon logging off, the status of the user may be changed to “offline.” In some example implementations, when the user re-logs into the contextual collaboration workspace, the system changes the status back to “do not disturb,” as had previously been set In other implementations, the persistence state is not maintained. To this end, the system sets the status to a default state, such as “available” when the user logs into the contextual collaboration workspace.

In some example implementations, the contextual collaboration workspace 300 indicates each user's presence. The context list 102, in some example implementations, displays an owner- and/or creator-type user presence status (e.g., where the owner is the user associated with the contextual collaboration workspace).

In some example implementations, a user may have and/or set a default presence status upon logging into the contextual collaboration workspace. The user may indicate whether the user's status is to appear, upon logging in, as “available,” “busy,” “away,” or the like. In some example implementations, changes to the user's presence status, when set by the user, is reflected in all contextual collaborations with which the user is associated.

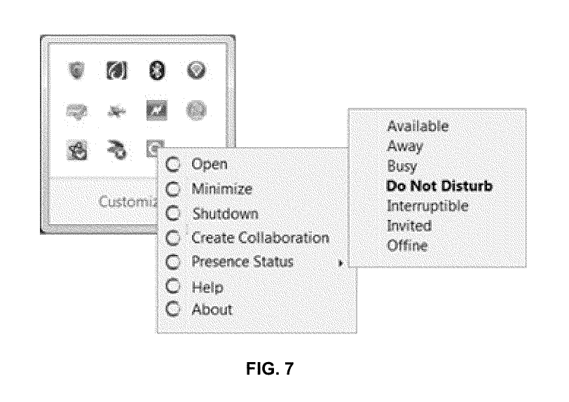

In some example implementations, contextual presence graphical user interfaces and/or contextual collaboration workspaces are shown in a system tray and/or toolbar, as described in further detail below with reference to FIG. 7. The user, in some example implementations, selects and/or sets a presence status (e.g., contextual collaboration specific, or application to all contextual collaborations with which the user is associated) through the system tray. As shown, the bold entry may show a presently selected configured state. If none of the options are bold, then the user's presence may be determined by the contextual presence system based on the workspace to which the user is accessing.

In some example implementations, the participant list 302 lists and/or includes users that are logged into the system. In other example implementations, the participant list 302 is lists users associated with the contextual collaboration corresponding to contextual collaboration workspace 302. The participant list 302 may graphically distinguish, using font style, size, colors, and the like, users that are currently logged in and users that are not logged in.

By determining a presence status based on contextual collaboration-specific actions (e.g., actions occurring within and/or in connection with a contextual collaboration), the collaboration and engagement between users within the contextual collaboration is promoted. For example, users associated with a contextual collaboration may collaborate in and/or by: modifying the list of users associated with that collaboration (e.g., adding or deleting users or owners); adding tasks and/or assigning users to tasks; adding and/or removing files, documents, and/or resources associated with the contextual collaboration; instantiating live-share sessions; editing documents and files associated with the contextual collaboration; applying version numbers to files and/or document; setting permissions; setting priorities; setting expiration dates and times; deleting and archiving the contextual collaboration; searching and/or analyzing the contextual collaboration; and changing states of the contextual collaboration. Examples of features of the contextual collaboration to which such collaboration among users may be used are described in International Application Number PCT/US14/59154, filed Oct. 3, 2014 and titled “SYSTEMS AND METHODS FOR ENTERPRISE MANAGEMENT USING CONTEXTUAL GRAPHS,” the entire contents of which are incorporated herein by reference in their entirety.

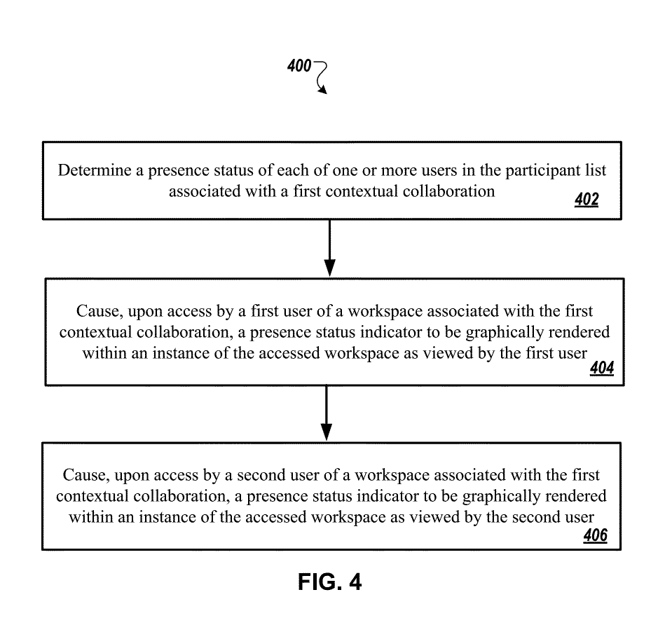

FIG. 4 is a flowchart illustrating a method 400 for providing the presence status of users associated with a contextual collaboration, in accordance with an exemplary embodiment. In some example implementations, providing the presence status of users includes notifying a first user, via a participant list in a contextual collaboration workspace, of the presence of other users associated with the contextual collaboration. In some example implementations, the presence status of users refers to the status of users with respect to a specific contextual collaboration. In some example implementations, the presence status of users associated with a contextual collaboration is provided (e.g., transmitted, displayed) to and/or via contextual collaboration workspaces corresponding to the contextual collaboration.

At step 402, a presence status of users associated with a contextual collaboration is determined. In some example implementations, the presence status of a user is the status (e.g., active, inactive) of the user with respect to a contextual collaboration. Determining the presence status of users (e.g., step 402) may be performed by a contextual collaboration management system or by computing devices corresponding to each of the users. For example, a contextual collaboration management system may request, receive, and/or store the presence status of users and, in turn, transmit the presence status of one or more users to the users' computing devices. Alternatively or additionally, the computing devices of each user may individually request, receive, and/or store the presence status of users, and transmit and/or display those presence statutes via a participant list in a contextual collaboration workspace. It should be understood that the presence statuses that may be requested and/or received by a user's computing device may depend (e.g., be filtered, restricted) on the permissions of the requesting and/or receiving user. That is, for example, if a user only has permission to communicate and/or view the presence status of a subset of users associated with a contextual collaboration (e.g., region, team, department), the user's computing device does not request and/or receive the presence status of the users to which it does not have permission. In some example implementations, the presence status indicates access, by a user, of a contextual collaboration and/or documents and/or resources associated with the contextual collaboration.

At step 404, the received, retrieved and/or determined presence statuses are displayed via and/or transmitted to a first contextual collaboration workspace of a first user, for example, when the first user accesses the first contextual collaboration workspace. A presence status indicator may be used to illustrate (e.g., in a presence list) the presence status of the users associated with a contextual collaboration. In some example implementations, the presence status indicator is graphically rendered within a workspace (e.g., workspace window, workspace instance) corresponding to a first user. In some implementations, the indicator graphically indicates a presence status of users in a participant list associated with a contextual collaboration workspace associated with a contextual collaboration.

In some example implementations, the presence status indicator graphically indicates the one or more users who are accessing a contextual collaboration. For example, the presence status indicator may indicate an interruptible status for a user if the user is accessing the same contextual collaboration as that being accessed by the first user and/or may indicate an unavailable status if the user is accessing a different contextual collaboration from that being accessed by the first user.

At step 406, the received, retrieved and/or determined presence statuses are displayed via and/or transmitted to a second contextual collaboration workspace of a second user, for example, when the second user accesses the second contextual collaboration. A presence status indicator may illustrate (e.g., in a presence list) the presence status of the first user (as well as other users) with respect to the contextual collaboration corresponding to the second contextual collaboration workspace. In some example implementations, the presence status indicator graphically indicates a presence status of one or more other users in the participant list associated with the contextual collaboration.

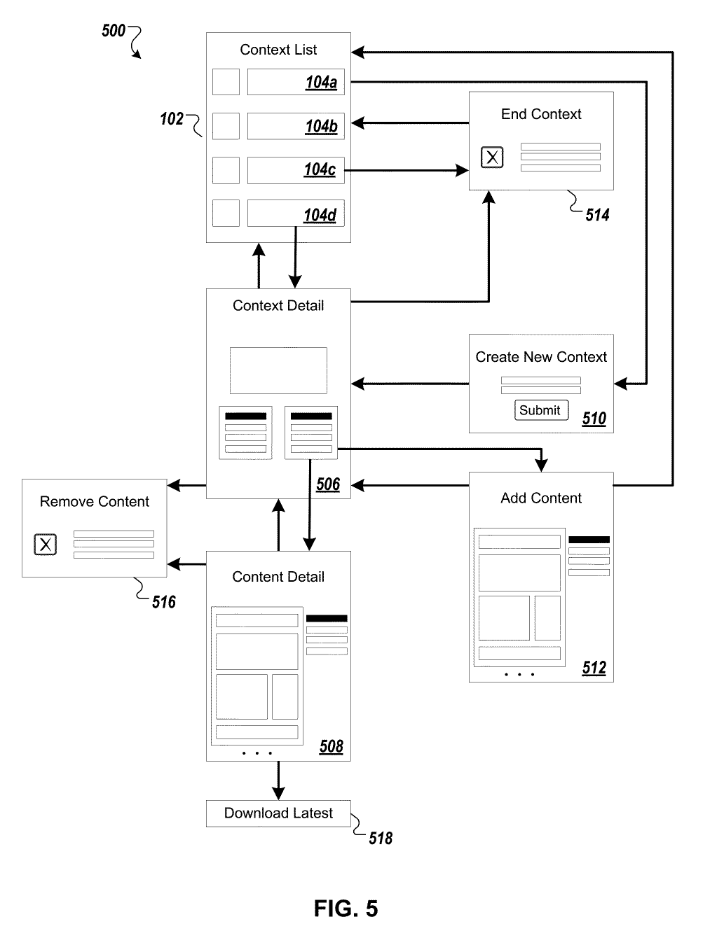

FIG. 5 is a block diagram of a system 500 for enterprise management using contextual collaborations (e.g., contextual graphs), according to an exemplary embodiment. In some example implementations, the system 500 is an enterprise system that provides contextual collaborations 104 (e.g., 104a, 104b, 104c, 104d) that relate documents, resources, and the like that occur and/or are used in business workflows. The contextual collaborations 104 may be displayed and/or provided on a context list 102, and may be organized, for example, based on time or priority level. In this way, the system can output (e.g., display, transmit, provide), and a user can access and/or view, the timeline or priority level of projects, tasks and the like associated with the contextual collaborations 104 (and documents and/or resources associated therewith).

The context list 102 enables access to the resources associated with the contextual collaborations 104 in the context list 102. Examples of resources include one or more persons, documents, locations (e.g., rooms, buildings), devices, assignments, printers, presentation hardware, computers, display monitors, tasks, calendars, documents, multimedia files (e.g., videos), graphics, audio files, and the like.

For example, a user may select a contextual collaboration 104d and view context details 506 associated with the contextual collaboration 104d. In some example implementations, the contextual collaboration 104d is a meeting includes and/or is associated with contents (e.g., content details) 508. The context detail 506 provides content (e.g., the content itself, and/or a relationship or link associated with the content), such as the attendees of the meeting, the documents to be presented in the meeting, devices (e.g., projectors or displays) to be used in the meeting and/or the scheduled time. At block 518, details regarding the content 508 (e.g., content detail) associated with the contextual collaboration 104d in the context list 102 may be downloaded.

A contextual collaboration (e.g., contextual collaboration 510) may be added to the context list 102. A contextual collaboration (e.g., contextual collaboration 514) may be deleted and/or removed from the context list 102. In some example implementations, the context list 102 is updated when contextual collaborations are added or removed from a context list 102. Similarly, in some example implementations, the system updates the contextual collaboration 506 and/or the context list 102 when content is added to or removed from a context detail 506.

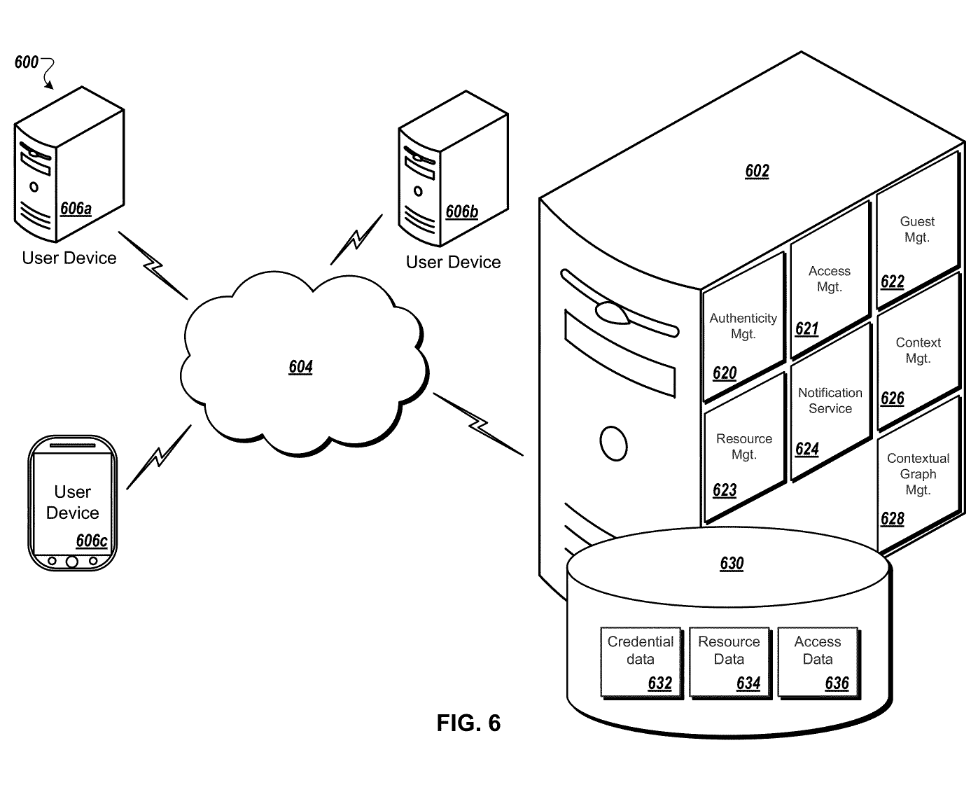

FIG. 6 is a block diagram of a system 600 for enterprise management using contextual collaborations (e.g., contextual graphs), according to an exemplary embodiment. The system 600 includes an enterprise system 602, user computing devices 606a, 606b and 606c (collectively “606” or “user devices 606”), and a network 604. The enterprise system 602 may be accessed from one of the user devices 606 via the network 604. In some example implementations, each of the computing devices 606 is configured with a client application that provides access to features and functions provided by the enterprise system 602. The enterprise system 602 includes one or more processors for controlling the functionality of the enterprise system 602. The computing devices 602 may be desktop computers, laptops, workstations, personal digital assistants, cellular telephones, smart-phones, tablets, and other similar computing devices. The network 604 may be the Internet, an intra-enterprise network, and/or other similar networks, or a combination thereof.

The computing devices 606 may access the enterprise system 602, for example, by inputting and/or transmitting login information to the enterprise system 602. In some example implementations, an authenticity module 620 authenticates the login information (e.g., associated with a user). The authenticity module 620 may compare the login information to credential data 632 stored in a data store 630. The data store 630 may be one or more memory devices attached to and/or in communication with the enterprise system 602. The login information and/or the credential data 632 includes, for example, a username, password, name, address, phone number, age, security question information, date of birth, place of birth, identification number, social security number, telephone number, email address, passport number, company name, group name, business unit name, an employee identification number, biometric characteristics (e.g., fingerprints, palm prints, iris scan, retina scan, facial scan, hand geometry, odor, vein pattern, voiceprint, typing rhythm, gait, dynamic signature, static signature), or the like, or any combination thereof. The credential data 632, in some implementations, may be provided and/or stored during or subsequent to a registration process.

In turn (e.g., after login information has been authenticated by the authenticity module 620) a context list may be presented via a contextual collaboration workspace, as described above in more detail with reference to FIGS. 1-5.

In one example implementation, upon accessing an application, a user is prompted for login credentials. The input login credentials are in turn validated against a configured AD/LDAP server (e.g., an active directory and/or lightweight directory access protocol server) or internally in the case of an internally defined system or system created user. If the user has previously signed on and they have not logged out of the system, the user may not be required to go through the login procedure. After gaining access to the system, the user is presented with the main window of the application. That is, a window application is displayed at a computing device operated by and/or associated with the user.

A contextual collaboration (e.g., graph) management module 628 manages contextual lists and a context management module 626 manages each of the contextual collaborations. The context management module 626 and contextual collaboration management module 628, in some example implementations, work together to create and update a business workflow model (e.g., a contextual collaboration and/or graph) for an enterprise. The modules described herein may be separate modules, combined into a single module, or distributed into any number of modules. A context list may be created for each user associated with the enterprise (e.g., employees of the enterprise, guests of the enterprise, administrators of the enterprise, etc.). Each context list may be tailored and/or designed specifically for each user or group of users, and contains one or more contextual collaborations. A context list enables access to resources assigned to and/or associated with a contextual collaboration in the context list.

In some example implementations, a user requests to authorize another user (e.g., guest user) for guest access to a set of system and/or contextual collaboration resources. The guest user may already be a registered user or may be a new user to the system. A guest management module 622, in some implementations, controls guest access to the system, including authorizing the guest user to access the requested resources or a subset of the requested resources. The authorization, in some implementations, is based on specific name of the user or a domain identifier associated with an organization of which the user is a member.

For example, an enterprise may maintain a system (e.g., enterprise system 602), as described in the present application. A user of the system may be an employee of the enterprise. The employee may request that another user (e.g., guest user) receive guest access to the system. The guest user may be a non-employee of the enterprise. The non-employee guest user may be a contract worker, friend, family member, business associate, or have some other similar relationship with the employee. For example, an employee may wish to register a spouse as a guest so the spouse can access information on the system relevant to health benefits. The employee may also request to provide guest access to a contract worker so that the contract worker can perform his/her required duties. In each case, the access may be preset and/or is configurable by, in this example, the employee so that the guest can access the appropriate system resources.

Guest users may submit requests for access to a set of resources by another guest user. In some example implementations, guest users are not permitted to request access to the system by another guest user. For example, only users registered with the system are permitted to submit requests to authorize users for guest access to the system. In some example implementations, the system permits a guest user to request a second guest user. This may be limited to situations when the second guest user has been previously registered with the system or when the second guest user meets a predetermined qualification (e.g., if the guests are coworkers).

Credentials associated with the new guest user may be received. In some example implementations, the set of credentials are stored in the credential data 632 in the data store 630. The set of credentials associated with the guest user may be provided by a user, the guest user, or by both a user and the guest user. For example, the user may provide one credential of the set of credentials and the guest user provide another credential of the set of credentials. The set of credentials and/or other information associated with the guest user may be stored for future use.

In some example implementations, the guest management module 622 verifies that the second set of credentials associated with the second user meet one or more predetermined criteria for guest-level access to the system. For example, the guest management module 522 may verify that the second user is not prohibited from accessing a system resource that would otherwise be accessible based on the set of credentials. In some implementations, this is accomplished by verifying the user is not on a “no-access” list.

In some example implementations, after a user is authenticated, the user has access to a set of system resources. The set of system resources, in some implementations, is stored on the data store 630 and includes resource data 634. An access management module 621, in some example implementations, control a user's access to system resources. In some implementations, the access management module 621 controls both users that are employees of the enterprise and/or guest users.

For example, a user may be an employee with non-administrator employee access to system resources. When the employee logs into the system and is authenticated, the access management module 621 may limit the employee's access to system resources accessible to non-administrator employee access.

In some example implementations, a user's level of access may be based on one or more permissions associated with the user. The permissions may be based on access data 336 stored in the data store 630. If the user is a guest user, the type of access may be configurable by a registered user, such as the registered user that requested access for the guest user. A user's access may be controlled or set according to an administrator-configurable policy.

In some example implementations, the enterprise system 602 includes a resource management module 623. The resource management module 623 may manage access to resources. In some example implementations, the resource management module 623 restricts access to a resource (e.g., one user per resource at a given time). In some example implementations, multiple users may access a resource concurrently. That is, the resource management module 623 may allow multiple users to concurrently edit or alter resources, and manages and tracks the users that make edits when multiple users are editing a document. For example, when one user edits a document, changes that a user makes may be reflected in substantially real-time in the document and thus replicated and/or visible to all other users. If multiple users are editing the document, the changes a user makes may be identified so that other users are aware who made the edits.

In some example implementations, only one user may access a resource in a non-read-only mode. In some example implementations, the resource management module 623 tracks (e.g., stores) users that access a resource, when a resource is accessed, and any changes made to a resource. This information may be stored in the resource data 634 of the data store 630. The resource data 634 may include the resources themselves and/or information regarding the resources such as access history, information regarding changes to the resources, and the like.

The enterprise system 602, in some example implementations, includes a notification service 624 that provides notifications to users. Notification may be transmitted to an account associated with a user, such as through a user via email, text message, automated phone calls/messages, or other similar means.

The notification service 624 may transmit a notification to a system administrator indicating that the system received the request from a user to authorize a user for guest access to the system. The system administrator may be notified anytime someone tries to give any visitor access to the system. A user may receive a notification when their request to provide access to a guest user is approved and/or when their guest accesses a resource. In some example implementations, a user may receive a notification when a guest attempts to access a resource to which they do not have permission to access.

FIG. 7 illustrates a screenshot of a portion 700 of a graphical user interface for modifying a presence status in accordance with an exemplary embodiment. That is, FIG. 7 illustrates a system tray and/or toolbar displayed and/or rendered on a computing device. The system tray and/or toolbar may be used to set and/or view the presence status of a user associated with the computing device. The presence status may correspond to the contextual collaboration that is active and/or last accessed.

In some example implementations, contextual presence graphical user interfaces and/or contextual collaboration workspaces are shown in a system tray and/or toolbar, as described in further detail below with reference to FIG. 7. The user, in some example implementations, selects and/or sets a presence status (e.g., contextual collaboration specific, or application to all contextual collaborations with which the user is associated) through the system tray. As shown, the bold entry may show a presently selected configured state. If none of the options are bold, then the user's presence may be determined by the contextual presence system based on the workspace to which the user is accessing.

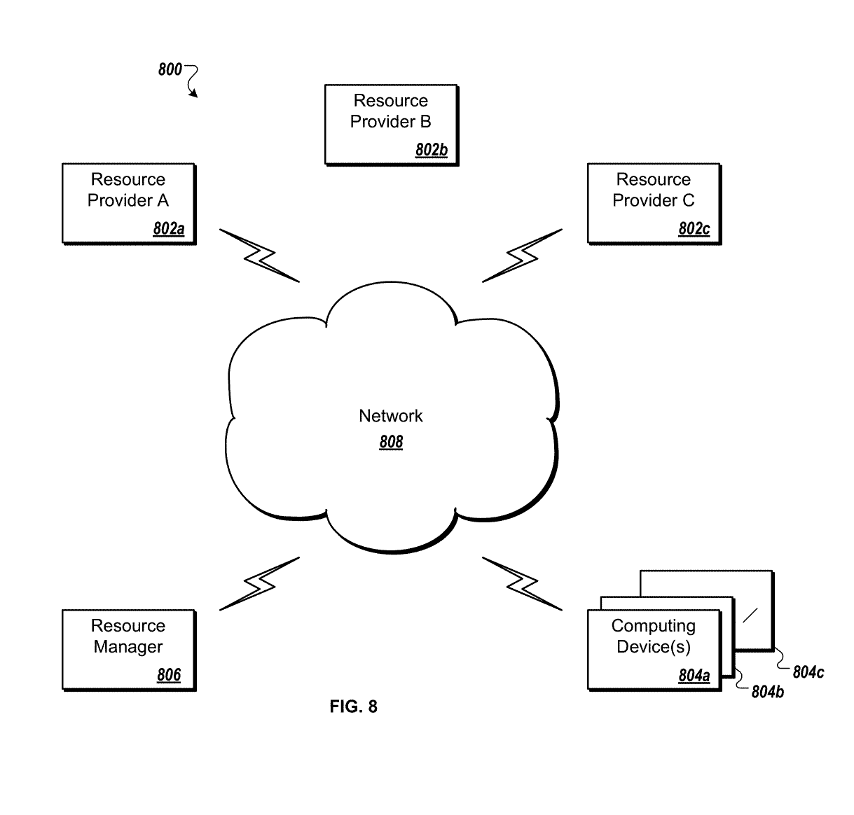

FIG. 8 illustrates an implementation of a network environment 800 for use in a system implementing a business workflow model. In brief overview, referring to FIG. 8, a block diagram of an exemplary cloud computing environment 800 is shown and described. The cloud computing environment 800 may include one or more resource providers 802a, 802b, 802c (collectively, 802). Each resource provider 802 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 802 may be connected to any other resource provider 802 in the cloud computing environment 800. In some implementations, the resource providers 802 may be connected over a computer network 808. Each resource provider 802 may be connected to one or more computing device 804a, 804b, 804c (collectively, 804), over the computer network 808.

The cloud computing environment 800 may include a resource manager 806. The resource manager 806 may be connected to the resource providers 802 and the computing devices 804 over the computer network 808. In some implementations, the resource manager 806 may facilitate the provision of computing resources by one or more resource providers 802 to one or more computing devices 804. The resource manager 806 may receive a request for a computing resource from a particular computing device 804. The resource manager 806 may identify one or more resource providers 802 capable of providing the computing resource requested by the computing device 804. The resource manager 806 may select a resource provider 802 to provide the computing resource. The resource manager 806 may facilitate a connection between the resource provider 802 and a particular computing device 804. In some implementations, the resource manager 806 may establish a connection between a particular resource provider 802 and a particular computing device 804. In some implementations, the resource manager 806 may redirect a particular computing device 804 to a particular resource provider 802 with the requested computing resource.

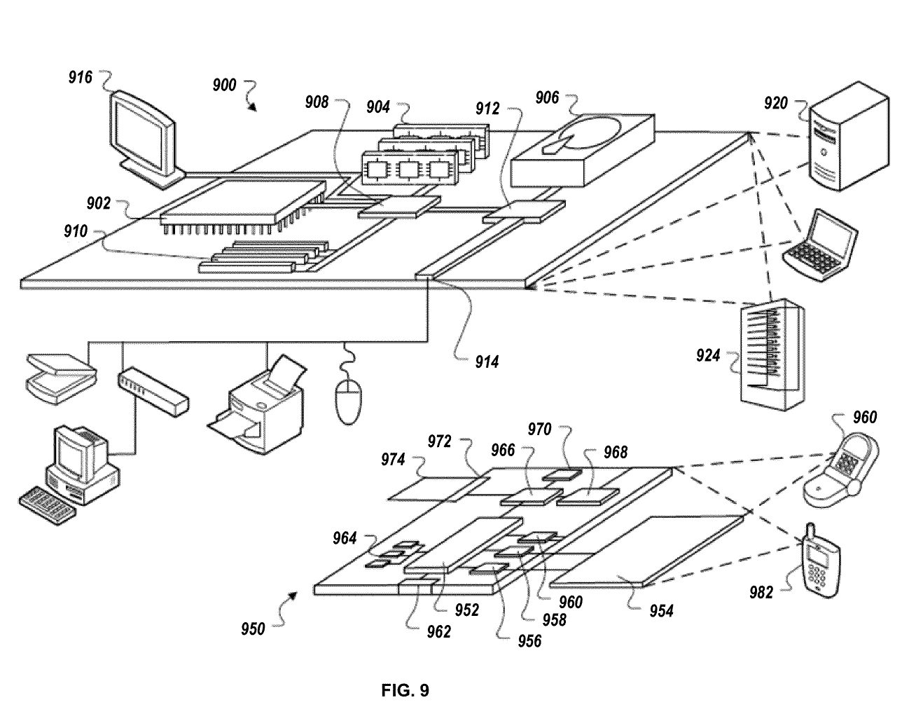

FIG. 9 illustrates an example of a computing device 900 and a mobile computing device 950 that can be used to implement the techniques described in this disclosure. The computing device 900 is intended to represent various forms of digital computers, such as laptops, desktops, workstations, personal digital assistants, servers, blade servers, mainframes, and other appropriate computers. The mobile computing device 950 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 may also be another form of computer-readable medium, such as a magnetic or optical disk.

The storage device 906 is capable of providing mass storage for the computing device 900. In some implementations, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 902), perform one or more methods, such as those described above. The instructions can also be stored by one or more storage devices such as computer- or machine-readable mediums (for example, the memory 904, the storage device 906, or memory on the processor 902).

The high-speed interface 908 manages bandwidth-intensive operations for the computing device 900, while the low-speed interface 912 manages lower bandwidth-intensive operations. Such allocation of functions is an example only. In some implementations, the high-speed interface 908 is coupled to the memory 904, the display 916 (e.g., through a graphics processor or accelerator), and to the high-speed expansion ports 910, which may accept various expansion cards (not shown). In the implementation, the low-speed interface 912 is coupled to the storage device 906 and the low-speed expansion port 914. The low-speed expansion port 914, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. In addition, it may be implemented in a personal computer such as a laptop computer 922. It may also be implemented as part of a rack server system 924. Alternatively, components from the computing device 900 may be combined with other components in a mobile device (not shown), such as a mobile computing device 950. Each of such devices may contain one or more of the computing device 900 and the mobile computing device 950, and an entire system may be made up of multiple computing devices communicating with each other.

The mobile computing device 950 includes a processor 952, a memory 964, an input/output device such as a display 954, a communication interface 966, and a transceiver 969, among other components. The mobile computing device 950 may also be provided with a storage device, such as a micro-drive or other device, to provide additional storage. Each of the processor 952, the memory 964, the display 954, the communication interface 966, and the transceiver 968, are interconnected using various buses, and several of the components may be mounted on a common motherboard or in other manners as appropriate.

The processor 952 can execute instructions within the mobile computing device 950, including instructions stored in the memory 964. The processor 952 may be implemented as a chipset of chips that include separate and multiple analog and digital processors. The processor 952 may provide, for example, for coordination of the other components of the mobile computing device 950, such as control of user interfaces, applications run by the mobile computing device 950, and wireless communication by the mobile computing device 950.

The processor 952 may communicate with a user through a control interface 958 and a display interface 956 coupled to the display 954. The display 954 may be, for example, a TFT (Thin-Film-Transistor Liquid Crystal Display) display or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may provide communication with the processor 952, so as to enable near area communication of the mobile computing device 950 with other devices. The external interface 962 may provide, for example, for wired communication in some implementations, or for wireless communication in other implementations, and multiple interfaces may also be used.

The memory 964 stores information within the mobile computing device 950. The memory 964 can be implemented as one or more of a computer-readable medium or media, a volatile memory unit or units, or a non-volatile memory unit or units. An expansion memory 974 may also be provided and connected to the mobile computing device 950 through an expansion interface 972, which may include, for example, a SIMM (Single In Line Memory Module) card interface. The expansion memory 974 may provide extra storage space for the mobile computing device 950, or may also store applications or other information for the mobile computing device 950. Specifically, the expansion memory 974 may include instructions to carry out or supplement the processes described above, and may include secure information also. Thus, for example, the expansion memory 974 may be provided as a security module for the mobile computing device 950, and may be programmed with instructions that permit secure use of the mobile computing device 950. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 952), perform one or more methods, such as those described above. The instructions can also be stored by one or more storage devices, such as one or more computer- or machine-readable mediums (for example, the memory 964, the expansion memory 974, or memory on the processor 952). In some implementations, the instructions can be received in a propagated signal, for example, over the transceiver 969 or the external interface 962.

The mobile computing device 950 may communicate wirelessly through the communication interface 966, which may include digital signal processing circuitry where necessary. The communication interface 966 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA 900, or GPRS (General Packet Radio Service), among others. Such communication may occur, for example, through the transceiver 968 using a radio-frequency. In addition, short-range communication may occur, such as using a Bluetooth®, Wi-Fi™, or other such transceiver (not shown). In addition, a GPS (Global Positioning System) receiver module 970 may provide additional navigation- and location-related wireless data to the mobile computing device 950, which may be used as appropriate by applications running on the mobile computing device 950.

The mobile computing device 950 may also communicate audibly using an audio codec 960, which may receive spoken information from a user and convert it to usable digital information. The audio codec 960 may likewise generate audible sound for a user, such as through a speaker, e.g., in a handset of the mobile computing device 950. Such sound may include sound from voice telephone calls, may include recorded sound (e.g., voice messages, music files, etc.) and may also include sound generated by applications operating on the mobile computing device 950.

The mobile computing device 950 may be implemented in a number of different forms, as shown in the figure. For example, it may be implemented as a cellular telephone 980. It may also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for creating and updating a business workflow model (contextual graph) for an enterprise are provided. Having described certain implementations of methods and apparatus for supporting a business workflow model, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously. Similarly, one or more modules may be combined into a single module and a single module as described may be separated into multiple modules. Moreover, it should be understood that the systems and methods implemented by a processor. When multiple processors are used, the processors may be located remotely from each other and communicate over a network.

Having described various embodiments of the disclose technology, it will now become apparent to one of skill in the art that other embodiments incorporating the concepts may be used. It is felt, therefore, that these embodiments should not be limited to the disclosed embodiments, but rather should be limited only by the spirit and scope of the following claims. Headers are provided for context and are not intended to be limiting.

1-8. (canceled)

9. A system for managing contextual collaborations, comprising:
a memory operable to store a plurality of contextual collaborations, each of the contextual collaborations being associated with a plurality of users and resources, and
a processor coupled to the memory, the processor being operable to:
receive, from a first computing device associated with a first user, a first interaction associated with a first contextual collaboration;
store, in the memory, the first interaction in association with the first user and the first contextual collaboration;
update a first status associated with the first user and the first contextual collaboration; and
transmit the first status, over a network, to computing devices associated with at least a first portion of the plurality of users associated with the first contextual collaboration, wherein
the first contextual collaboration is one of the plurality of contextual collaborations,
the first user is one of the plurality of users associated with the first contextual collaboration.

10. The system of claim 9, wherein the processor is further operable to:
receive, from a second computing device associated with a second user, a second interaction associated with the first contextual collaboration;
store, in the memory, the second interaction in association with the second user and the first contextual collaboration;
update a second status associated with the second user and the first contextual collaboration; and
transmit the second status, over the network, to the computing devices associated with at least a second portion of the plurality of users associated with the first contextual collaboration,
wherein the second user is one of the plurality of users associated with the second contextual collaboration.

11. The system of claim 10, wherein the first status and the second status are stored in the memory.

12. The system of claim 10, wherein the first interaction and the second interaction indicate actions performed, respectively, by the first user via the first computing device and the second user via the second computing device, on one of the plurality of resources associated with the first contextual collaboration.

13. The system of claim 12, wherein the actions include a read action and a write action.

14. The system of claim 12, wherein
the first interaction is associated with a first time, and the second interaction is associated with a second time,
the first status and the second status are updated based on the first time and the second time, respectively.

15. The system of claim 10, wherein the first portion and the second portion of the plurality of users are determined based on permissions associated with the first user and the second user, respectively.

16. The system of claim 10, wherein the processor is further operable to:
receive, from the first computing device associated with the first user, a third interaction associated with a second contextual collaboration;
store, in the memory, the third interaction is association with the first user and the second contextual collaboration;
update a third status associated with the first user and the second contextual collaboration; and
transmit the third status, over the network, to computing devices associated with at least a third portion of the plurality of users associated with the second contextual collaboration, wherein
the second user is not associated with the second contextual collaboration, and
the third status is not transmitted to the computing device of the second user.

17. The system of claim 9, wherein the processor is further operable to:
store, in the memory, user information associated with each of the plurality of users associated with the plurality of contextual collaborations,
wherein the user information includes at least a status associated with a contextual collaboration.

18. A system for managing contextual collaborations, comprising:
a memory, and
a processor coupled to the memory, the processor being operable to:
receive, over a network, a first set of statuses corresponding to a first set of users associated with a first contextual collaboration; and
cause to display, via a first contextual collaboration workspace associated with the first contextual collaboration, the first set of statuses corresponding to the first set of users associated with the first contextual collaboration;
wherein the causing to display the first set of statuses includes:
modifying, based on the first set of statuses, a status indicator corresponding to each of the first set of users, and
displaying the status indicators in a presence list of the first contextual collaboration workspace.

19. The system of claim 18, wherein the processor is further operable to store, in the memory, the first set of statuses in association with the first set of users and the first contextual collaboration.

20. The system of claim 18, wherein the receiving of the first set of statuses occurs in response to the processor receiving a successful access request.

21. The system of claim 18,
wherein each of the first set of statuses includes a corresponding time, and
wherein the first set of statuses caused to be displayed include statuses including a corresponding time within a predetermined time.

22. The system of claim 18, wherein the processor is further operable to:
receive, over the network, a second set of statuses corresponding to a second set of users associated with a second contextual collaboration, and
cause to display, via a second contextual collaboration workspace associated with the second contextual collaboration, the second set of statuses corresponding to the second set of users associated with the second contextual collaboration:
wherein the causing to display the second set of statuses includes:
modifying, based on the second set of statuses, a status indicator corresponding to each of the second set of users, and
displaying the status indicators in a presence list of the second contextual collaboration workspace.

23. The system of claim 22, wherein
the first set of users and the second set of users include a first user, and,
a status of the first user among the first set of statuses is different than a status of the first user among the second set of statuses.

24. The system of claim 22, wherein the first set of statuses and the second set of statuses are received from one of an enterprise system and a computing device associated with a user.
